(19) United States
(12) Patent Application Publication
(10) Pub. No.: US 2010/0185736 A1
(43) Pub. Date: Jul. 22, 2010

(54) INTERDEVICE TRANSMISSION OF DATA

(75) Inventor: Janakiram Jayaraman, Bangalore (IN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/520,540

(22) PCT Filed: Dec. 21, 2007
(86) PCT No.: PCT/GB2007/004950

§ 371 Date: Feb. 18, 2010

(30) Foreign Application Priority Data
Dec. 21, 2006 (GB) 0625638.2

(51) Int. Cl. G06F 15/16; G06F 3/048

(52) U.S. Cl. 709/206; 709/227; 709/217; 715/838; 709/231; 715/810

(57) ABSTRACT

The invention relates to a method of transmitting data from portable electronic devices to a communication network, such as the Internet, or a mobile phone network, and to a corresponding device and computer program product. An initiating device with a wireless link to the communication network is configured to access data on a subsidiary device using a local wired, or wireless connection. Reduced size representations of the data on the subsidiary device, such as thumbnails images, or filenames, are downloaded to the initiating device for selection. Having selected the data for transmission, and the mode of transmission, such as e-mail or MMS for example, the data is transmitted by streaming it from the subsidiary device over the local connection and into the outgoing data stream to the communication network. In this way, the initiating device need never store a complete copy of the file being transmitted.

The invention relates to a method of transmitting data from portable, electronic devices to a communication network, and to devices enabled to perform the method.

In recent years, consumer electronic devices have become increasingly interwoven with our everyday lives. Increased competition among manufacturers, and lower build prices for the component electronics, have seen prices fall to levels that are affordable to most, while new functionality has captured the interest and imagination of consumers everywhere. People now expect to make phone calls, take photographs, record video or sound, play games, connect to the Internet, and share data with friends or work colleagues, all while on the move using both wireless and wired connections. Consequently, it is now not uncommon for consumers to carry several electronic devices for data capture and playback with them at any one time. Such devices include mobile or cellular phones 2, personal digital assistants (PDAs) 4, with or without wireless e-mail capabilities, music or video players 6, digital cameras 8, video cameras 10 and laptops 12, as illustrated in FIG. 1. While such devices can operate independently of other devices, often they are intended to be used in conjunction with support software running on a user's home computer 14 or laptop 12 for example.

Increasingly, the functionality traditionally provided by separate devices is being merged into single devices with increased capabilities. A good example of this is the current generation of wireless handheld devices that combine the ability to take digital photographs and video clips, with the ability to make phone calls, browse the Internet and send emails, text and multimedia messages. Examples of such devices are mobile or cellular phones 2, and specialised wireless email devices such as BlackBerrys, and palmtop computers. However, it is still true that devices with dedicated functionalities can provide specialised capabilities that more generic devices cannot. For example, although wireless handheld devices are now typically provided with a camera or video camera function, the quality of photographs or video sequences captured is typically less than that provided by a dedicated digital camera or digital video camera, due to the necessary tradeoffs that must be made for the generic device to provide other functions. Further, in the case of wireless handheld devices, small size and light weight are becoming increasingly important to consumers, and memory and processor performance are therefore at a premium. A portable computing device, such as a laptop, for example, will easily outperform most handheld devices in terms of computing resources, but at the costs of a larger more cumbersome device. The manufacturers of portable handheld devices, and the providers of the software for such devices are therefore faced with the challenge of providing useful functionality for small devices with resources that are necessarily limited.

The development of technologies for inter-device connectivity has greatly benefited manufacturers, software providers, and consumers alike, by mitigating many of the limitations on resources. For example, music and/or video data, referred to as music or video content, can be stored on a user's home computer 16 and transferred to a portable handheld player 8 only when the user wishes to play the content. In this way, content that is played infrequently can be stored on the computer, and the more limited memory of the handheld device need not be used to store content that is of little immediate interest. Similarly, content from the handheld device can also be checked in to the computer for later playback when the user has tired of it. In other applications, files may be transferred between handheld computing devices, or image files may be downloaded from a digital camera to a mobile phone for later transmission by email or multimedia message.

Presently, there are a number of different technologies for connecting devices together making use of both wired and wireless connections. Such connectivity is sometimes described as short link, local transmission link, or a Personal Area Network (PAN) because the devices must be placed in proximity to one another for a connection to be possible. Depending on cable lengths, or wireless signal strengths, the range of such connections can typically vary up to 5 metres, but may be more. One such technology, called Universal Serial Bus (USB), refers to the combination of the cable, corresponding specialised ports on a computer and a connected device, and the signalling protocols, that allows data signals and power to be transferred between devices. Both of the computer and the portable device necessarily provide software support for the data transmission protocols along the cable. USB has greatly improved device connectivity as its operation is often automatic: a computer acting as host is configured to automatically detect that a device has been connected to its USB port via the cable and has been turned on. The computer then establishes a data exchange session with the device using the predefined USB signalling protocols. The user of the device does not need to take any special measures for the transfer of data to be possible, other than physically connect the devices together with the cable. A serial wired connection between devices may also be implemented using Firewire technology connections for example, favoured by previous models of digital video cameras and some music/video players, though these are often now implemented with USB.

Wireless connections between devices on the other hand are often implemented using Bluetooth. A Bluetooth enabled device has a radio frequency transmitter and receiver, and the necessary driving software for transmitting signals to and receiving signals from another Bluetooth enabled device. Some Bluetooth devices have a range of up to 100 m. The software on the device performs the encoding/decoding of data, and ensures that the signals are transmitted correctly according to the relevant transmission protocol. Other technologies for transmitting data between devices include Infrared transmitter and receiver protocols provided by the InfraRed Data Association (IrDA), and WiFi for example. One protocol for data transmission used with Bluetooth and IrDA is known as OBEX, short for Object Exchange; this is a communication protocol that allows the exchange of binary objects between devices.

While these technologies allow file and/or data transfer to easily occur between different devices, a user can still encounter difficulties with data and files that are large in size. For example, if a user wishes to transmit a file by email, multimedia message (MMS), or using a File Transfer Protocol (FTP) the file must be retrieved from the memory of the device and encapsulated in the relevant transmission protocol. If the file is located in the first instance on a device having no email, MMS or FTP capability, it must first be transferred to the memory of a device having such capability before transmission can occur. If the user subsequently has no use for the file on the transmitting device, then the user must then remember to delete the file from memory.

A good example of a situation in which these problems may be encountered is in the use of a digital camera with a mobile or cellular phone. Although mobile phones often provide camera functions, a digital camera will typically take pictures of a higher quality and store many more of these in the device. A photo taken by the digital camera may for example have a maximum pixel count that is twice as much as that for the mobile phone; the camera may also have the capacity to store say 50 times the number of pictures that can be stored by the phone, assuming the size and/or resolution of the pictures are the same. If a user wishes to transmit these pictures, while on the move, via email, MMS or FTP, it is necessary to download each and every picture to be transmitted onto the mobile phone before transmission takes place. Given the smaller memory size of the phone, this can be a laborious and time consuming process.

We have therefore appreciated that there is a need for a method of transmitting data from portable electronic devices that allows data to be handled by respective devices regardless of the data size or memory limitations of respective devices, and for a device that performs the method.

### SUMMARY OF THE INVENTION

The invention is defined in the independent claims to which reference should now be made. Advantageous features are set forth in the dependent claims.

The preferred embodiment of the invention relates to a method of transmitting data from portable electronic devices to a communication network, such as the Internet, or a mobile phone network, and to a corresponding device and computer program product. An initiating device with a wireless link to the communication network is configured to access data on a subsidiary device using a local wired, or wireless connection. Reduced size representations of the data on the subsidiary device, such as thumbnails images, or filenames, are downloaded to the initiating device for selection. Having selected the data for transmission, and the mode of transmission, such as e-mail or MMS for example, the data is transmitted by streaming it from the subsidiary device over the local connection and into the outgoing data stream to the communication network. In this way, the initiating device need never store a complete copy of the file being transmitted.

### BRIEF DESCRIPTION OF THE DRAWINGS

Preferred embodiments of the invention will now be described by way of example and with reference to the drawings, in which:

FIG. 1 is an illustration of example portable electronic devices that may be used with the preferred embodiment of the invention;

FIG. 2 is a schematic illustration of the components of a portable electronic device, such as that used in the preferred embodiment of the invention;

FIG. 3 is a schematic illustration of two portable electronic devices operating according to the invention;

FIG. 4 is an illustration of the internal configuration of a device according to a preferred embodiment;

FIG. 5 is a flowchart showing the operation of the application shown in FIG. 4; and

FIG. 6 is an illustration of a screen shot of the device that is operating according to the invention, showing a file viewing application.

### DETAILED DESCRIPTION OF THE PREFERRED EMBODIMENTS

The preferred embodiment of the invention takes the form of a portable electronic device provided with functionality for addressing the problems identified above. In particular, the preferred embodiment of the invention takes the form of a portable electronic device that has the capability to transmit data by email, multimedia message, or FTP to a user selected transmission destination across a communication network. The communication network preferably is a wireless network, such as a Global System for Mobile communications (GSM) network, GRPS and/or EDGE (enhanced data rates for GSM evolution) enabled mobile networks, 3rd Generation mobile communication network, or wireless LAN for example. In other embodiments it may also be a public or private switched telephone network. The communication network is intended to include the Internet.

Furthermore, the preferred embodiment of the invention provides functionality that allows the user of the portable electronic device to determine what data or data files are stored on a second or subsidiary electronic device; and select data or data files from the second electronic device for inclusion in the email, multimedia message or FTP transfer.

The term ‘streaming’ is known in the art to describe the transfer of data in which both receiving and transmitting applications process the data in a steady and continuous stream. A file of data, commonly representing video or audio content, need not be transmitted in full to a receiving device before the receiving device can make use of the data. The data is typically packetised before being transmitted to a receiving device, and the receiving device can begin to playout the received packets before all packets relating to a file have been received. Streaming therefore permits fast use of data received from a network or another device.

To enable streaming, a buffer is required in the receiving device for storing the data before it is used, and since this buffer need not hold the entire file at once, memory efficiency savings may be made by providing a relatively small buffer sufficient for streaming, rather than allocating a large area in memory to hold the entire file.

In the context of the present invention, the term ‘streaming’ is used to reflect the fact that the transmission of the data from the first portable device begins before the data transfer from the second device to the first has been completed. In this way, the first portable device may stream the data from the second device into its own transmission stream as it is received from the second portable device. As will be appreciated from the following discussion, a buffer is provided at the first portable device to accommodate the data and provide some tolerance to delays and other operational factors. The preferred embodiment of the invention is thus configured so that the data file or data from the second device need not be fully downloaded to the portable electronic device that is transmitting; instead the portable electronic device reads the data from the second electronic device at the time transmission from the first device takes place, and streams the data into the relevant email, MMS, of FTP transmission protocol. In this way, size limitations of the memory of the portable electronic device are not an obstacle to the transmission of large data files, and there is no need to delete the data from the memory of the portable electronic device once transmission has occurred (as it has never been stored in a complete form).

It will be appreciated that although the data transfer will continue until all of the data has been transmitted from the first device, the streaming in this case will not necessarily be continuous or steady. For example, transmission from the second device might be halted momentarily if it is detected that the buffer in the first device has become full. Also, in the rare occasions where the data being streamed is smaller in size than that of the buffer, it may be that all of the data can be transferred in advance and transmitted normally. This is clearly an exception however and is unlikely to occur given that in normal everyday usage the data that users transmit will typically be considerably larger than any buffer that can be practically provided.

As the first portable device streams the data into its normal transmission protocol, it will be imperceptible at the destination receiver, whether the data was stored in a complete form on the first device or not: the receiving side application will simply detect the reception of an email and attachment, and MMS or a FTP transfer. No special steps or configuration at the receiver are therefore required for use with the preferred embodiment. The operation and implementation of the preferred embodiment will become more clear from the following discussion.

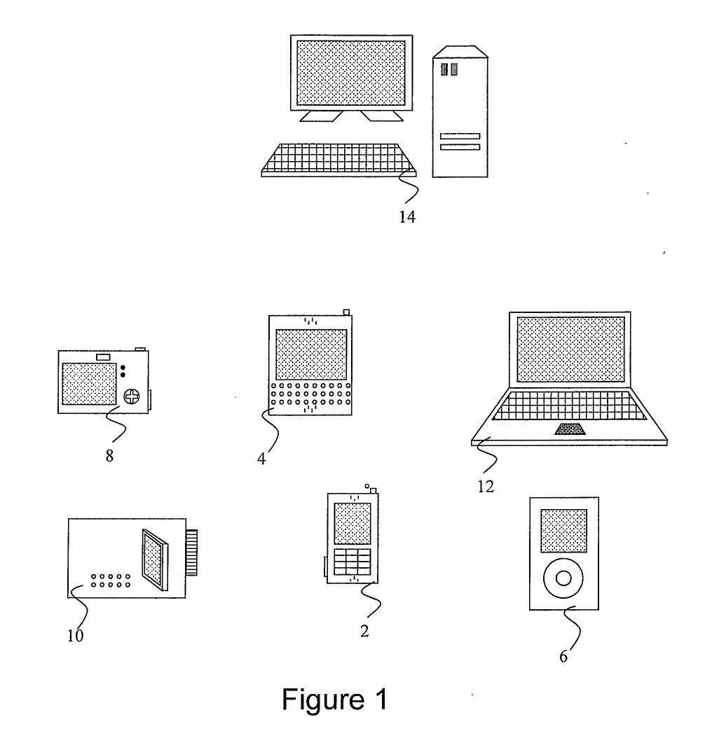

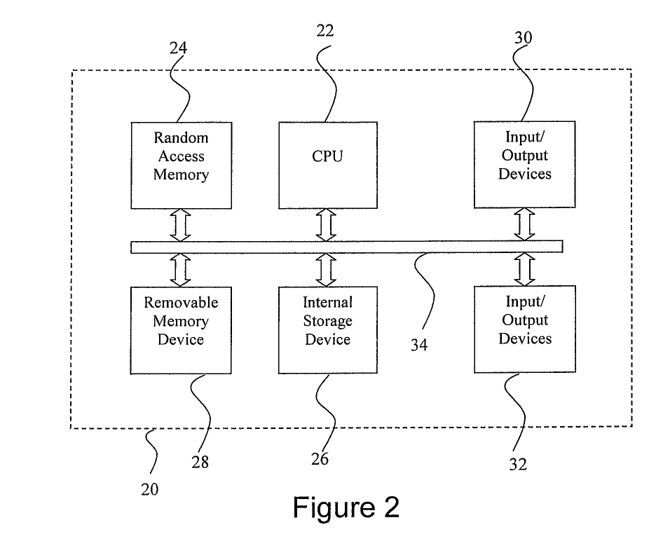

FIG. 2, shows in a simplified form the internal components of a general portable electronic device 20 such as those illustrated in FIG. 1. The device typically comprises a Central Processing Unit (CPU) 22 with access to primary memory 24 (Random Access Memory), and additional memory devices, such as an internal storage device 26 or hard disk drive, and removable memory device 28. The removable memory device could be a memory card or microdrive for example. The device also comprises Input/Output device interfaces 30 and 32. Although only two interfaces are shown, the device may comprise any number of interfaces providing connection to a user keyboard, a display screen, output speaker or microphone, and input/output communication ports such as USB, Firewire, Bluetooth, WiFi or an InfraRed port. Data is transmitted between the CPU, the various types of memory, and the Input/Output ports by bus 34, which includes both the data and address bus.

In the case where the electronic device has a telephone function, one of the Input/Output devices will be a system comprising a microphone for capturing the voice of the user, and a speaker for playing back the voice of the other participant in the telephone call. The system will also necessarily comprise an analogue-to-digital (ADC), and digital-to-analogue (DAC) converters for converting the speech signals to digital form, although these are not shown in the diagram. Such a device will also necessarily have an antenna for transmitting signals to a wireless communication network, and a coder/decoder (CODEC) section for converting speech signals into a signal suitable for transmission on the wireless link.

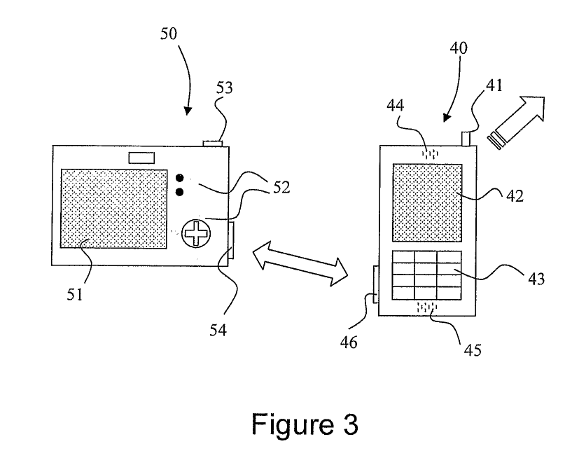

The advantages provided by the preferred embodiment of the invention will be better understood with reference to FIG. 3. FIG. 3 shows a mobile or cellular phone 40, having an antenna 41, a screen 42, a key pad 43, a speaker 44 and microphone 45, and a communication port 46 for inter-device communication. The communication port can provide (PAN) connection capability by any suitable means such as USB, Firewire, Bluetooth, WiFi, Infrared Port and so on. The device 40 could also be a personal digital assistant, a palmtop computer and so on. In this example, the second device 50 is a digital camera, having a screen 51, user input function buttons 52, a shutter release button 53, and communication port 54 for inter-device communication.

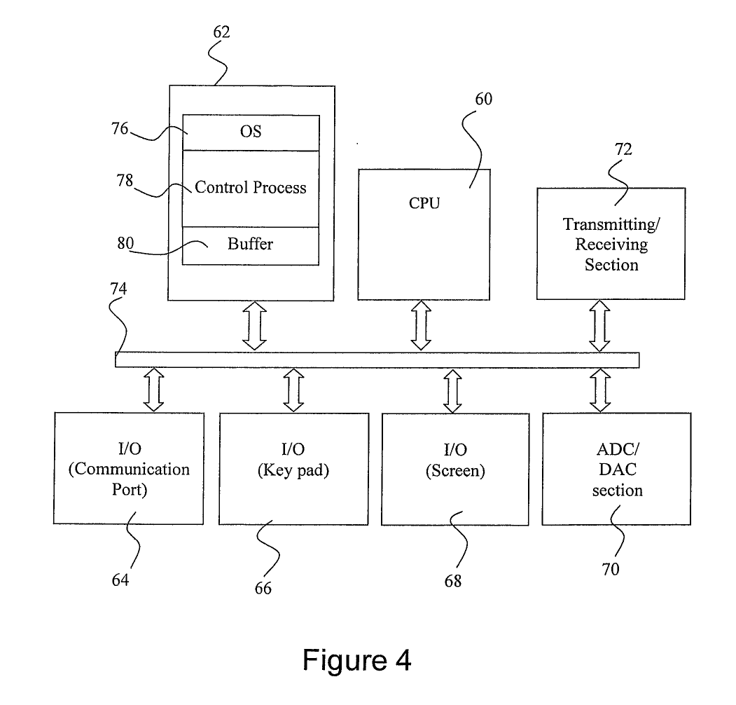

The internal configuration of the mobile or cellular phone according to the preferred embodiment of the invention is shown in FIG. 4. The device comprises a CPU 60, a Random Access Memory 62, and several Input/Output interfaces such as a communication port interface 64 for connecting to external port 46, keypad interface 66 for connecting to keypad 43, screen interface 68 for connecting to screen or display 42, and ADC/DAC 70 for connecting to microphone 45 and speaker 44, and transmitting and receiving section 70 for connecting to antenna 41. Each of the components are linked by general bus 74, which comprises control bus, address bus and data bus functions. A removable storage interface (not shown) may also be provided.

Random Access Memory 62 contains program instructions defining the mobile phone Operating System 76 (OS) that provides all of the necessary control and access functions for a user to operate the phone, such as getting user input, operating the various I/O devices, controlling the screen, and so on. The OS or other applications running in conjunction with the OS also provide the user with higher level functionality for operating the phone, such as address book functions, composing and transmitting emails and/or multimedia applications, establishing an ftp connection, and establishing a connection to another device via the communications port interface 64 and port 46.

Additionally, the memory 62 contains program code that forms a controller 78. The controller 78 can be implemented separately to the OS, such as a dedicated application, program or process, or as part of the OS 76 itself. The controller 78 provides the functionality and the necessary user interfaces for a user to determine what data or data files are stored on a secondary connected device, to select one of those files for transmission, and to stream that data from the secondary device to the end transmission destination. Controller 78 achieves this by reserving a portion of memory 62 for use as a buffer 80. Thus, successive portions of the data or data file are downloaded to the buffer for encoding into the relevant transmission protocol for transmission from the transmitting/receiving section 70 and antenna 41. The buffer could also be provided on a removable storage device or hard disk, if available.

In this way, the data or data file need never exist in a complete form in the memory of the mobile phone, so a lack of available memory space in the phone to store the complete data or data file is no impediment to transmission of the data file using the phone. This is especially important in the example shown in FIG. 3, as high resolution image files captured by the digital camera and easily stored in the memory of the digital camera would occupy a significant portion of the mobile phone memory if they were to be transferred and stored in a complete form.

Additionally, if the user wishes to transmit several images or files, it may not be possible for them to download and store on the mobile phone all of the files that are to be included in the outgoing transmission, because of insufficient memory space. In this case, a user would not be able to transmit the images from the camera while he was on the move, but would have to wait until he had access to his home or office computer, or to a laptop with an internet connection.

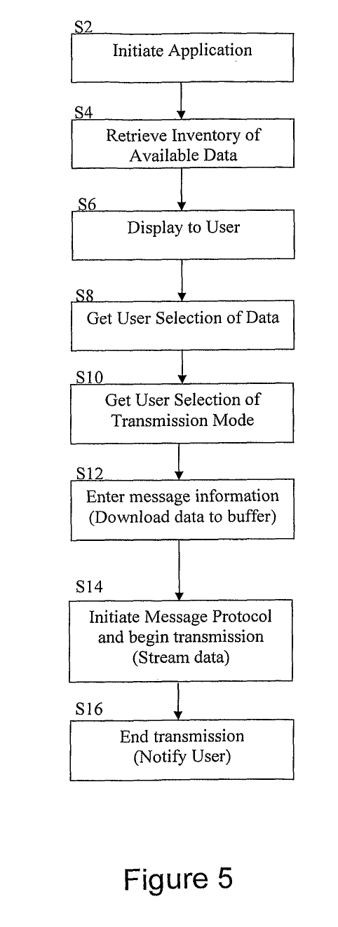

The operation of the controller 78 will now be described in more detail with reference to the Flowchart of FIG. 5. In Step S2, the controller 78 for transmitting the data from the secondary device is initiated. Initiation could occur in response to the user of the mobile phone selecting an icon or menu option from the standard user interface of the phone. Preferably however, the OS detects when another device has been placed in connection with the mobile phone either through a USB or other wired connection, or wirelessly through a technology such as Bluetooth, WiFi or IrDA link, and automatically launches the application in anticipation of further instructions from the user.

The USB protocol specifies that USB enabled devices monitor their USB port and detect when a connection with another USB device has been established. If a connection is detected then data is exchanged over the connection to determine the various parameters of the two connected devices; the respective device Operating Systems can then take action as a result; such as making available data files, or device commands to the connected device. Thus, to establish the connection and establish a situation in which data exchange between devices may occur, the user merely has to physically connect the two devices together using a USB cable. With two handheld devices as described in this example the USB protocol in use is likely to be USB On-The-Go (OTG) as this allows any USB device to act as a hosting device to establish the connection.

Bluetooth, and Infrared wireless connections operate in a similar way, except that a user typically has to turn on the Bluetooth or Infrared port and place the two devices in range for transmission to take place. For Infrared connections, the Infrared ports must also be angled towards each other for a connection to be established. Deliberate activation by the user is necessary to avoid draining the battery by transmitting and monitoring signals when no data transmission is to take place.

Thus, in Step S2, once the controller 78 is initiated, it creates a buffer in memory for the subsequent download of information for use by the controller in and any further transmission. The buffer is preferably circular, meaning the position in the buffer at which data is written moves forward after each write action, but cycles back to the beginning of the buffer once the pointer has reached the end of the buffer. The same is true for the pointer indicating the location in the buffer from which data should be read. The read and write pointers are separate, and for the circular buffer to operate successfully, the write pointer should not catch up with read pointer (if it does, unread data is erased as new data is written).

The size of the buffer created may be determined by any of the various appropriate techniques known in the art. Relevant considerations include the overall amount of memory available in a device, latency in the device, and the connection type. Currently, in a typical portable electronic device, 128 bytes represents a common size for a small buffer.

In Step S4, the controller uses the relevant session communication protocol, such as USB or Bluetooth to access the data on the connected device. In the case of image data, the controller is configured to provide thumbnail reproductions of each of the images available on the camera, and present these to the user of the phone. Most operating systems provide functionality for generating thumbnail views of image data that is stored, and it is straightforward to provide such a function on either the camera or the phone. The controller may therefore make a call to a thumbnail generator function on the camera if this is available, and download the subsequent thumbnails to the phone for viewing. Alternatively, the thumbnails could be generated by a thumbnail generation function that is provided either as part of the controller or separately and accessible to it, once the controller has identified from the session protocol the addressing information for the images stored on the camera.

The thumbnail image representations are physically much smaller in size, and much lower in quality than the original image data. Preferably therefore, the thumbnails generated are stored in the buffer memory area of the phone, but if buffer space is not sufficient, then the regular memory of the phone can also be used.

Preferably, as well as, or instead of a thumbnail view, the images can be presented to the user as a sorted list. Such a list might be sorted by the date and/or time the image was captured, or even the geographical location where the image was captured, if the camera provides a GPS (Global Positioning System) label for the captured image. A user interface provided by the controller allows the user of the phone to select their preferred mode of viewing the file data, so that they can simply view thumbnails, or by sorting, even select images that relate to an event given by a time and place.

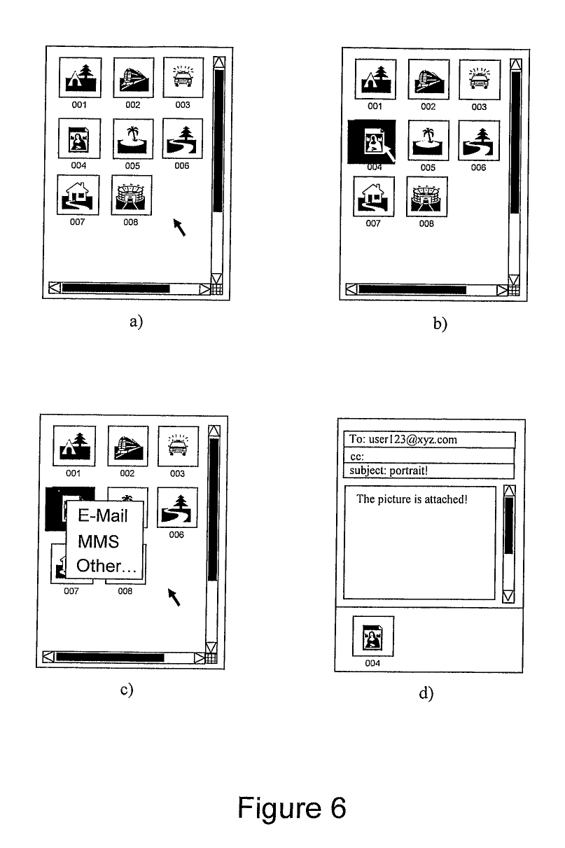

In Step S6, the controller controls the display of the mobile phone to present to the user both the thumbnails and a graphical user interface for selecting a thumbnail for transmission. An example screen shot of the display screen is shown in FIG. 6. In this case, the controller 78 has determined that there are eight images stored on the digital camera and has presented eight corresponding thumbnails images to the user via the user interface (see screen a). If there were more than eight images available these may be navigated to in known fashion by manipulating the scroll bars at the side of the screen.

In step S8, the controller then waits for user input to make a selection. Depending on the device, a user can select an image thumbnail by either moving a mouselike pointer over the image and operating a selection button on the housing of the phone, or by physically touching the screen over the desired image using a stylus or other input device. In screen b) the image corresponding to thumbnail number 004 has been selected.

Once an image has been selected, the controller presents in step S10 a menu setting out the different options for transmission of the data (see screen c). These may include E-Mail, Multimedia Message, FTP, or any other transmission protocol such as direct transfer between devices supported by the phone. In the example shown, the user opts to transmit the image by email. The controller then presents the user with a screen for the input of the email header and body information into an email template. The selected thumbnail, or text identifier, is also preferably shown in the attachment window, to indicate that the email will be sent with the attached file once the email is completed. The user enters any associated information for inclusion in the email, such as address, in step S12, and having done so, clicks on or selects the ‘send’ option. As explained in the next step in more detail, the email is then sent, and the data for the attachment streamed through the outgoing data session. Preferably, the email functionality, or MMS functionality, is provided by the controller 78 itself, but in alternative embodiments the controller 78 may simply launch a separate dedicated email or MMS program and pass information defining the location of the selected image as a parameter to the program call creating the new email or MMS.

Also in step S12, while the user is entering the other information and data for the message body and header, the controller clears the buffer and begins to download the data for the selected image into the buffer 80. This is to ensure that when the user has finished entering the message data and has clicked ‘send’, image data is immediately available for transmission over the wireless communications session. The download continues until the buffer is full, and then pauses for further input.

Once the user has completed the input of the email data, and selected the send option, the controller 78 encodes, in step S14, the email body and header data, as well as a reference to the attachment, in the appropriate email format for transmission. This data is passed to the Transmitting/Receiving Section 72, which subsequently converts it into signals suitable for transmission over the communications network to the destination address indicated in the email.

The controller 78 simultaneously begins to encode the image data that has already been downloaded in the buffer 80 into the appropriate format for transmission. This is also passed to the Transmitting/Receiving section 72 for inclusion in the outgoing stream as an attachment to the outgoing email. As data is read out of the buffer 80 and passed to the transmitting/receiving section, the controller 78 downloads subsequent image data from the digital camera into the buffer 80 for encoding and transmission. In this way, the image data is downloaded segment by segment according to the available capacity of the buffer 80, immediately encoded, and passed directly to the transmitting/receiving section for transmission over the communications network. Thus, the image is never stored on the mobile phone in a complete form, but is streamed, or only intermittently stored, while encoding and transmission take place. The data may remain in the buffer during the encoding and transmission process, or may be extracted from the buffer for encoding and then passed onto the transmission section 72.

Once the image has been completely downloaded, the controller transmits data confirming that the transmission is complete in step S16, and notifies the user, by creating a visual representation on the screen of the phone.

From the perspective of the receiving server on the communications network, the e-mail looks no different to an e-mail that would have been produced had the image been fully downloaded and stored on the mobile phone in advance. The only difference is in the generation of email itself as this is transmitted from the device.

It will be appreciated that for optimum transmission, the speed at which the data is transmitted to the communication network, should be similar to the speed at which the image data is received in the buffer from the connected device, encoded, and passed to the transmitting/receiving section for transmission. Optimally, the buffer is only completely emptied at the end of the transmission process, and completely full at the start. However, both of the processes controlling the transmission link to the connected device and to the communication network will tolerate some mismatch in speed. If the image data does not keep up with the outgoing transmission protocol for example, the transmitting controller may introduce a delay to allow the buffer to refill before transmission continues. Similarly, a delay in the download from the connected device may be introduced if the controller detects that the buffer has become full.

It will be understood by the skilled person that many techniques are available for controlling flow rate between devices over a data link. Buffer size, latency and connection type should be considered, and a suitable technique may be employed for controlling the rate of transmission from the transmitting device in order to ensure that the receiving device can handle all incoming data. The transmission rate should be sufficiently slow that the receiving device does not lose data (thus requiring re-transmission, and increasing the overall time for the transfer), while being sufficiently fast that the receiving device can be continuously employed in processing the received data.

The above example illustrates the benefits provided by the invention when it is implemented on a mobile or cellular phone cooperating with a digital camera as a secondary device. However, it will be appreciated that the invention has a wide variety of applications and could be used on any portable device to transfer data files by streaming without ever having a complete representation of the data on the portable device. For example, the connected secondary device could be a video camera, a personal digital assistant or palmtop computer without access to a wireless communication network, a video or music player, or a games player. The secondary device could even be a laptop or portable personal computer, if the user wishes to transmit the data via the phone, by email or MMS.

Additionally, although the above example has referred to image data, any data could be transferred in this way. Examples are documents files, pdf files, music files, video files, executable files, zipped files, indeed anything that a user may wish to send to another location using the portable device. Thumbnails can be produced for more than just image files. For example, a thumbnail of a pdf or a document file may also be produced. Where a thumbnail is not appropriate, because of the data content, the filename or other identifier could be provided in the graphical user interface for selection.

Also, although the example above uses a cellular phone as the device on which the controller 78 runs, it will be appreciated that such functionality could be provided on any device with access to a wireless communication network, such as a portable digital assistant, or even a laptop. However, the benefits of the invention will be most apparent on devices where memory is limited.

Furthermore, the controller running on the initiating device may have a different implementation to that described above. For example, the functionality to access the data on the connected subsidiary device could be provided as part of existing programs for composing e-mail or MMS messages. In this way, a user would first select the type of message they wished to send, and subsequently indicate to the program that they wished to attach data or a data file. The messaging application would then request the user to indicate the location of the file to be attached, and the user would select the connected subsidiary device. The operation of the program would then be as before, downloading the thumbnail images for user selection.

Furthermore, in the example above, although the presentation of information about the data stored on the second device is made via a graphical user interface on the first portable electronic device, it is possible that the user selection of data for transmission be made by interacting with a program running on the second device. In the case of a camera for example, the user may operate a “set” button, on the camera to indicate to the first portable device which file is to be transmitted. This would be possible, once the first portable electronic device and the second device had established contact.

Although the above discussion has referred to data files, the data transmitted need not be in file format to be transmitted. Parts of a data file, for example a video sequence extracted from a larger file, could be extracted in the subsidiary device and streamed.

The above discussion is purely illustrative, and so is not intended to be limiting. The invention is defined in the following claims.

1. A method for transmitting data from a first portable electronic device to a communication network, the method comprising:
establishing a local transmission link between the first portable electronic device and a second device on which the data is stored; and
streaming the data from the second device to the communication network via a controller running on the first portable electronic device.

2-34. (canceled)

35. The method of claim 1, wherein the streaming step comprises:
allocating a region of memory in the first portable electronic device to receive user-selected data from the second device;
downloading to the allocated region of memory a first data portion from the user-selected data stored on the second device;
transmitting the first data portion from the first portable electronic device;
using the allocated memory to receive subsequent data portions from the second device until all of the user-selected data has been delivered to the first portable electronic device for transmission onto the network;
wherein the step of transmitting the first data portion occurs before all of the user-selected data has been delivered to the first portable electronic device.

36. The method of claim 1, further comprising:
presenting to a user of the first portable electronic device a list of data files stored on the second device;
receiving a user selection of a data file, whereby the data file is transmitted from the second device via the first portable electronic device to the network.

37. The method of claim 36, comprising wherein the step of presenting the list of data files occurs automatically in response to the establishment of the local transmission link between the first and second device.

38. The method of claim 36, wherein the list of data files is presented to the user via a graphical user interface running on the first portable electronic device.

39. The method of claim 38, comprising downloading thumbnail images that correspond to any image files stored on the second device, whereby a user of the first portable electronic device can select a thumbnail image to select a data files for transmission.

40. The method of claim 36, wherein the list of data files is presented to the user via a graphical user interface running on the second device.

41. The method of claim 1, wherein the controller running on the first portable electronic device has an email transmission function, and/or a multimedia message transmission function.

42. The method of claim 41, wherein the data selected for transmission is transmitted as an attachment to the email or to the multimedia message.

43. The method of claim 35, wherein the region of memory allocated is determined independently of the size of the data file to be transmitted.

44. The method of claim 1, wherein the local transmission link is provided by one of the following technologies: Universal Serial Bus, FireWire, Bluetooth, WiFi connection, Infrared connection.

45. The method of claim 1, wherein the second device is a portable electronic device.

46. The method of claim 45, wherein the second device is a digital camera.

47. The method of claim 1, wherein the communication network is a wireless communication network.

48. The method of claim 1, wherein the first portable electronic device has a mobile telephone function.

49. A portable electronic device for transmitting data to a communication network, the device comprising a processor configured to:
establish a local transmission link between the first portable electronic device and a second device on which the data is stored; and
stream the data from the second device to the communication network via a controller running on the first portable electronic device.

50. The device of claim 49, wherein the processor is configured in the steaming step to:
allocate a region of memory in the first portable electronic device to receive user-selected data from the second device;
download to the allocated region of memory a first data portion from the user-selected data stored on the second device;
transmit the first data portion from the first portable electronic device;
use the allocated memory to receive subsequent data portions from the second device until the user-selected data has been delivered to the first portable electronic device for transmission onto the network;
wherein the processor is configured to transmit the first data portion before all of the user-selected data has been delivered to the first portable electronic device.

51. The device of claim 49, wherein the processor is further configured to:
present to a user of the first portable electronic device a list of data files stored on the second device;
receive a user selection of a data file, whereby the data file is transmitted from the second device via the first portable electronic device to the network.

52. The device of claim 51, wherein the processor is configured to automatically present the list of data files stored on the second device, when a local transmission link between the first and second device is established.

53. The device of claim 51, wherein the list of data files is presented to the user via a graphical user interface running on the first portable electronic device.

54. The device of claim 53, wherein the processor is configured to download thumbnail images corresponding to any image files stored on the second device, whereby a user of the first portable electronic device can select a thumbnail image to select a data file for transmission.

55. The device of claim 51, wherein the list of data files is presented to the user via a graphical user interface running on the second device.

56. The device of claim 49, wherein the controller running on the first portable electronic device has an email transmission function, and/or a multimedia message transmission function.

57. The device of claim 56, wherein the data file selected for transmission is transmitted as an attachment to the email or to the multimedia message.

58. The device of claim 49, wherein the region of memory allocated is determined independently of the size of the data file to be transmitted.

59. The device of claim 49, wherein the transmission link is provided by one of the following technologies: Universal Serial Bus, FireWire, Bluetooth, WiFi connection, Infrared connection.

60. The device of claim 49, wherein the processor is configured to establish the local transmission link with a second device that is a portable electronic device.

61. The device of claim 60, wherein the processor is configured to establish the local transmission link with a digital camera.

62. The device of claim 49, wherein the communication network is a wireless communication network.

63. The device of claim 49 having a mobile telephone function.

64. A computer program product, having computer program code stored thereon which when executed on a processor, causes the processor to perform:
establishing a local transmission link between the first portable electronic device and a second device on which the data is stored; and
streaming the data from the second device to the communication network via a controller running on the first portable electronic device.
